(19) United States
(12) Patent Application Publication
(10) Pub. No.: US 2017/0314326 A1
(43) Pub. Date: Nov. 2, 2017

(54) WIRE MESH SECURITY WINDOW FRAME AND ASSEMBLY

(71) Applicant: Kane Innovations, Inc., Erie, PA (US)

(72) Inventors: Curtis E. Johnson, Kane, PA (US); Charles E. Gilmore, Ridgway, PA (US)

(73) Assignee: Kane Innovations, Inc., Erie, PA (US)

(21) Appl. No.: 15/583,903

(22) Filed: May 1, 2017

Related U.S. Application Data
(60) Provisional application No. 62/329,964, filed on Apr. 29, 2016.

(51) Int. Cl. E06B 9/52; E06B 3/96

(52) U.S. Cl. CPC E06B 9/52; E06B 3/962; E06B 2009/527

(57) ABSTRACT

A security window comprises a mesh infill and a plurality of extruded window frame elements arranged to form a polygon. Each said extruded window frame element comprises a front frame portion, a side frame portion, a retainer bar and a hinge that connects the front frame portion to the retainer bar. The retainer bar is oriented to receive the mesh infill such that the mesh infill is pressed between the front frame portion and the retainer bar and is also wrapped around the retainer bar.

### BACKGROUND

What is disclosed is an extruded window frame element and manufacturing process for the assembly of security windows that captures and holds mesh infills into a frame without the use of mechanical fasteners. The fabrication incorporates previous multiple components into a single extrusion where a wire mesh infill material is more strongly held in the frame without using any mechanical fasteners. This provides an aesthetically pleasing, cost effective solution while providing the required security requirements of the current market.

### SUMMARY

What is presented is a security window comprising a mesh infill and a plurality of extruded window frame elements arranged to form a polygon. Each extruded window frame element comprises a front frame portion, a side frame portion, a retainer bar, and a hinge that connects the front frame portion to the retainer bar. The retainer bar is oriented to receive the mesh infill such that the mesh infill is pressed between the front frame portion and the retainer bar and is also wrapped around the retainer bar.

Some embodiments of the extruded window frame elements have a plurality of teeth located between the front frame portion and the retainer bar to further secure the mesh infill between the front frame portion and the retainer bar.

Some embodiments of the window frame elements further have openings in the side frame portion to receive a compression connection. In such embodiments, a compression cover may be installed. The compression cover comprises a compression connection that fits into the opening and a mesh cover that extends from the compression connection to the hinge to cover the mesh infill between the mesh cover and the retainer bar. Some embodiments of compression covers could include accessories located adjacent to the side frame portion to provide additional functionality to the finished security window.

Some embodiments of the extruded window frame elements may have gaskets interposed between the side frame portion and the mesh infill. Some embodiments of the extruded window frame elements have mitered corners that allow for easier assembly of the finished security window. A corner cover may optionally be used between each adjacent pair of extruded window frame elements to secure each adjacent pair of extruded window frame elements together.

Those skilled in the art will realize that this invention is capable of embodiments that are different from those shown and that details of the apparatus and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1A shows a cross sectional view of an embodiment of an extruded window frame element with a mesh infill being installed between the retainer bar and the front frame;

FIG. 1B shows the extruded window frame element of FIG. 1A after the retainer bar has been compressed with the mesh infill pressed between the retainer bar and the front frame and the mesh infill wrapping around the retainer bar and the optional gasket being installed between the side frame and the mesh infill;

FIG. 1C shows the fully assembled extruded window frame element of FIG. 1A;

FIG. 2 shows a cross sectional view of another embodiment of fully assembled extruded window frame elements in which the side frame portion has an opening to receive a compression connection;

FIG. 3 shows a cross sectional view of another embodiment of fully assembled extruded window frame elements in which the side frame portion has an opening to receive a compression connection and a compression cover that incorporates an additional shape for mounting into a window sliding track;

FIG. 4 shows a cross sectional view of another embodiment of fully assembled extruded window frame elements in which the side frame portion has an opening to receive a compression connection and a compression cover that incorporates a decorative frame mount; and

FIG. 5 shows an embodiment of two adjacent fully assembled extruded window frame elements;

FIG. 6 shows the two adjacent fully assembled extruded window frame elements of FIG. 5 with a corner cover that secures them together; and

FIG. 7 shows the front frame view of an embodiment of two adjacent fully assembled extruded window frame elements in which the extruded window frame elements have mitered corners.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

Security windows comprising mesh infills are typically secured with fasteners to a frame assembly that is also held together with a plurality of fasteners. The mesh infills are typically made of metal wire, strong extruded plastic, plastic coated wire, or other strong fibers. The strength of the security window in prior art systems is determined by the strength of the mesh infill and the strength of the fasteners that secured the mesh infill to the frame. If the fasteners were stronger than the mesh infill, then the mesh infill is the weak point in the security window and the mesh infill would tear at the fasteners. If the mesh infill was stronger than the fasteners or the frame then either the fasteners would rip from the frame or the frame would collapse into its constituent elements and compromise the window. Constructing such security windows are also tedious and expensive as a worker is required to install each fastener.

The challenge was to provide a cost-effective product that meets the security needs required and reduces the material and labor costs to compete in the market. Prior art products rely on mechanical fasteners and an extrusion or bar to attach wire cloth infills to a frame. The extrusion, frame, and mechanical fasteners are all separate pieces. To manufacture the prior art products, holes must be drilled in the frame and typically screws installed to hold the frame, extrusion, and wire mesh cloth infill together, plus additional costs for tooling, fabricating, and finishing each component.

What is disclosed is an extruded window frame element and manufacturing process for the assembly of security windows that captures and holds mesh infills into a frame without the use of mechanical fasteners. The fabrication incorporates components into a single extrusion where a wire mesh infill material is more strongly held in the frame without using any mechanical fasteners. This provides an aesthetically pleasing, cost effective solution while providing the required security requirements of the current market.

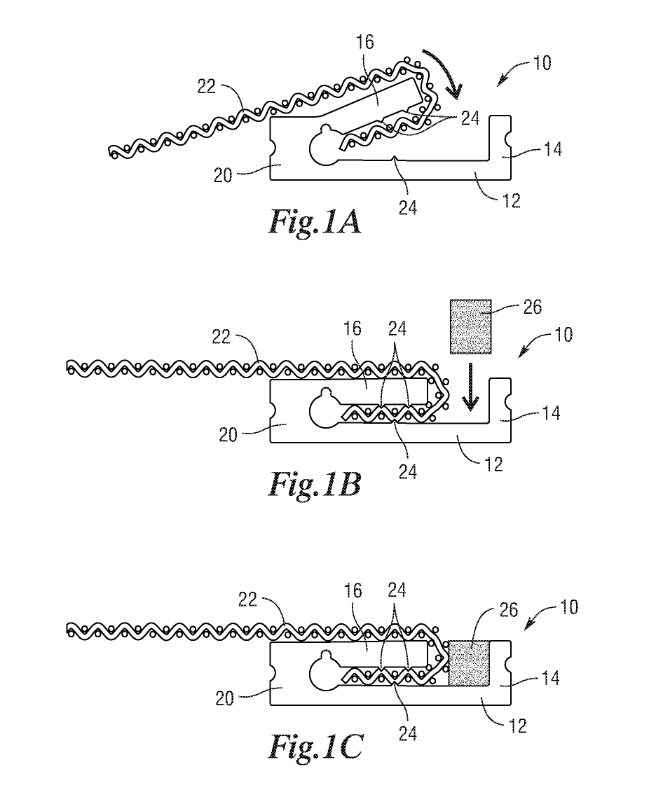

The security window comprises a series of extruded window frame elements 10 that form each side of the security window. FIGS. 1A-1C shows cross-sectional views of an embodiment of extruded window frame elements 10 as each side of the security window is assembled. Each extruded window frame element 10 comprises an outward facing front frame portion 12, a side frame portion 14 that fits into the space set aside for the security window, a rear facing retainer bar 16, and a hinge 20 that connects the front frame portion 12 to the retainer bar 16. The retainer bar 16 is oriented to receive a mesh infill 22 such that the mesh infill 22 must be wrapped around the retainer bar 16 and inserted between the retainer bar 16 and the front frame portion 12. As shown in FIG. 1B, the assembly is compressed by a machine to push the retainer bar 16 against the mesh infill 22 between the front frame portion 12 and the retainer bar 16 and the mesh infill 22 remains wrapped around the retainer bar 16. In some embodiments, as shown in FIGS. 1B and 1C, a gasket 26 may be incorporated to fill the space between the side frame portion 14 and the mesh infill 22. This would help keep the mesh infill 22 in place in the extruded window frame element 10.

The wrapping of the mesh infill 22 around the retainer bar 16 is an essential feature as it provides additional strength to the completed security window. If the mesh infill 22 were not wrapped around the retainer bar 16, it would only be the pressure on the mesh infill 22 from the retainer bar 16 and the front frame portion 12 that would be holding the mesh infill 22 in place. However, wrapping the mesh infill 22 around the retainer bar 16 provides additional support and strength to the system. As compared to prior art systems where the mesh infill is held in place by fasteners, in the system disclosed herein, contact with the mesh infill 22 is spread over the entire surface of the mesh infill 22 that is held between the retainer bar 16 and the front frame portion 12 and, additionally, the wrapping of the mesh infill 22 around the retainer bar 16 holds the mesh infill 22 even more securely in the completed security window.

A number of teeth 24 may optionally be incorporated into the retainer bar 16 and the front frame portion 12 that are in contact with the mesh infill 22. These teeth 24 would provide additional support to hold the mesh infill 22 in place.

The assembly disclosed herein eliminates the need for mechanical fasteners and separate frame and extrusion pieces. This eliminates multiple steps in the manufacturing process over the prior art thereby reducing the amount of labor required to assemble each security window. The improved security window incorporates multiple components into one component per side. Each side of the security window is one piece rather than multiple pieces. No holes are required to be drilled and separate pieces put together.

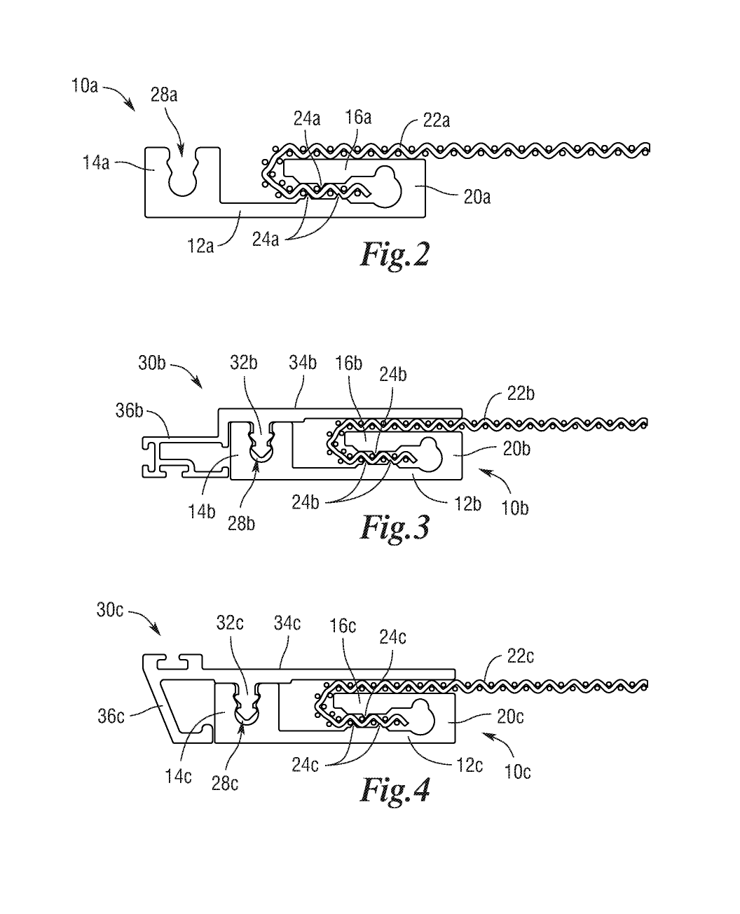

In other embodiments, as shown for example in FIG. 2, the extruded window frame element 10a has an opening 28a in the side frame portion 14a to receive a compression connection. The opening 28a is oriented to be behind the front frame portion 12a so that it is not visible from the front of a completed security window. This opening 28a would allow for accessories that incorporate additional functionality to be included with the completed security window.

FIG. 3 shows another embodiment of extruded window frame element 10b that also has an opening 28b in the side frame portion 14b to receive a compression connection. In FIG. 3, a compression cover 30b that has a compression connection 32b that fits in the opening 28b is installed in the extruded window frame element 10b. The compression cover 30b includes a mesh cover 34b that extends from the compression connection 32b to the hinge 20b to cover the mesh infill 22b between the mesh cover 34b and the retainer bar 16b when the extruded window frame element 10b is installed to create a security window. The compression cover 30b also includes an accessory 36b that provides additional functionality to the extruded window frame element 10b. In the example shown in FIG. 3, the accessory 36b is a window sliding track that will allow the completed security window to be installed in window and be slid out of the way.

FIG. 4 shows another embodiment of extruded window frame element 10c that also has an opening 28c in the side frame portion 14c to receive a compression connection. In FIG. 4, a compression cover 30c that has a compression connection 32c that fits in the opening 28c is installed in the extruded window frame element 10c. The compression cover 30c includes a mesh cover 34c that extends from the compression connection 32c to the hinge 20c to cover the mesh infill 22c between the mesh cover 34c and the retainer bar 16c when the extruded window frame element 10c is installed to create a security window. The compression cover 30b also includes an accessory 36c that in the example shown in FIG. 4, incorporates an extruded section that provides a decorative finish for the completed security window.

It will be understood that other accessories than the window sliding track and the decorative frame disclosed herein could be substituted for the accessory shown in FIGS. 3 and 4.

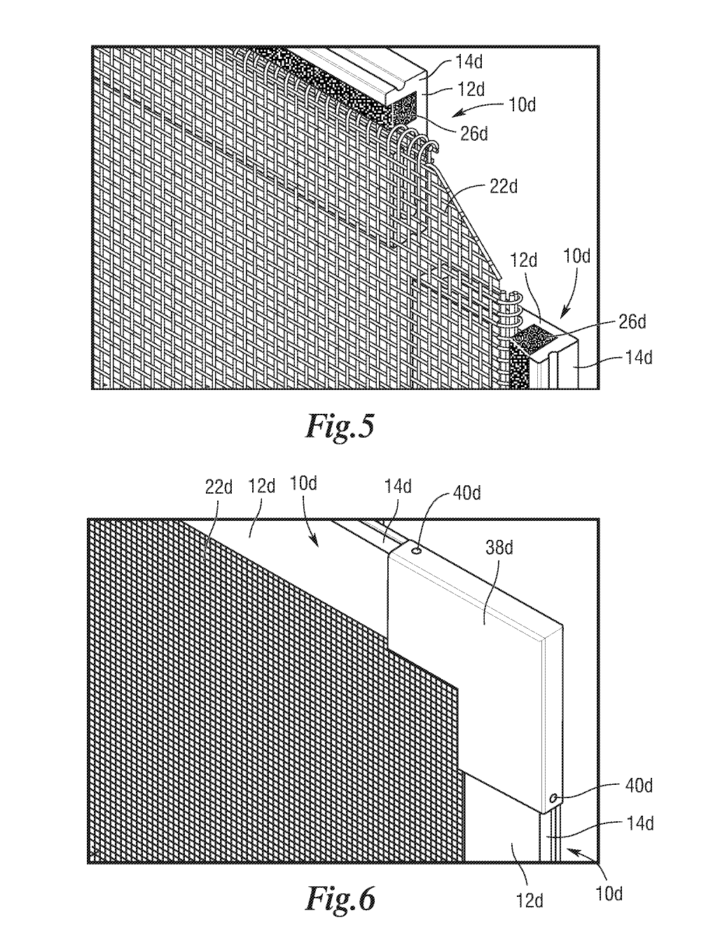

While security windows are typically rectangular in shape, a window may have any number of sides. While the concept disclosed herein could even be applied to circular windows, the typical configuration is that of polygon of at least three sides. Regardless of the final shape of the security window, FIG. 5 shows that when all the extruded window frame elements 10d of the frame are completed, each side of the completed window has a gap between adjacent sides. FIG. 6 shows that a corner piece 38d is riveted at the rivet opening 40d to adjacent extruded window frame elements 10d to create a complete security window. This assembly reduces the manufacturing time over prior art systems from approximately five hours to just fifteen minutes. This process reduces the number of manufacturing steps by 55%, reduces the number of components by 46%, and reduces the number of processes by 68% from prior art products used in the market. The overall frame depth is reduced by 35% over prior art products creating a more aesthetically pleasing product. Also, the wire infills are held in place more securely. In addition to linking each extruded window frame elements 10d together, the corner piece 38d provides additional security as it reduces outside access to the ends of the extruded window frame elements 10d.

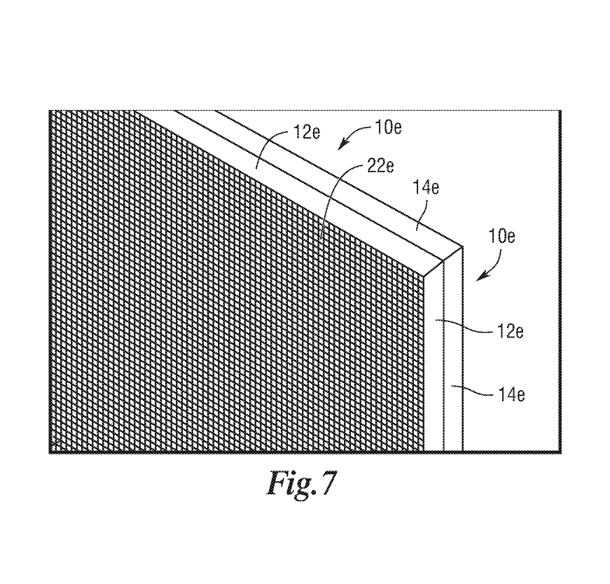

FIG. 7 shows an embodiment in which the extruded window frame elements 10e have mitered corners which allows adjacent extruded window frame elements 10e to be assembled flush next to each other. This makes assembly of the finished security window easier. A corner key (not shown) is used in such instances to connect the extruded window frame elements 10e together in an aesthetically pleasing manner. A corner piece (not shown) may also be used in such instances to hide the frame edge and as additional security to prevent the ends of extruded window frame elements 10e from being pried apart.

The extruded window frame elements disclosed herein allows for an improved method for assembling a security window. For a selected security window configuration, a mesh infill is hemmed to fit the desired size, shape, and number of sides. A number of extruded window frame elements is selected that equals the number of sides of the mesh infill. Each extruded window frame element has the front frame portion, side frame portion, retainer bar, and hinge that connects the front frame portion to the retainer bar as described above. Each side of the mesh infill is inserted into an extruded window frame element between the retainer bar and the front frame portion. The mesh infill is aligned so that it further wraps around the retainer bar. The retainer bar is then compressed so that the mesh infill is pressed and secured between the retainer bar and the front frame portion to create a window frame mesh assembly. A gasket may be inserted between the mesh infill and the side frame portion of each window frame mesh assembly to secure the mesh infill against the side frame portion.

Where the mesh infill comprises three or more sides, each pair of adjacent window frame mesh assemblies may be secured to a corner cover to create a complete security window. This is not necessary for those extruded window frame elements that have mitered ends but would provide additional security as mentioned above. If the side frame portion of each extruded window frame element has an opening to receive a compression connection, a compression cover as described above may be installed on the completed window frame mesh assemblies.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A security window comprising:
a mesh infill;
a plurality of extruded window frame elements arranged to form a polygon, each said extruded window frame element comprising:
a front frame portion;
a side frame portion;
a retainer bar; and
a hinge that connects said front frame portion to said retainer bar, said retainer bar oriented to receive said mesh infill such that said mesh infill is pressed between said front frame portion and said retainer bar and is also wrapped around said retainer bar.

2. The security window of claim 1 in which each said extruded window frame element further comprises a plurality of teeth located between said front frame portion and said retainer bar to further secure the mesh infill between said front frame portion and said retainer bar.

3. The security widow of claim 1 in which each said extruded window frame element further comprises said side frame portion has an opening to receive a compression connection.

4. The security widow of claim 1 in which each said extruded window frame element further comprises
said side frame portion has an opening to receive a compression connection; and
a compression cover comprising:
a compression connection that fits into said opening; and
a mesh cover that extends from said compression connection to said hinge to cover said mesh infill between said mesh cover and said retainer bar.

5. The security widow of claim 1 in which each said extruded window frame element further comprises
said side frame portion has an opening to receive a compression connection; and
a compression cover comprising:
a compression connection that fits into said opening;
a mesh cover that extends from said compression connection to said hinge to cover said mesh infill between said mesh cover and said retainer bar; and
an accessory located adjacent to said side frame portion.

6. The security window of claim 1 in which each said extruded window frame element further comprises a gasket interposed between said side frame portion and said mesh infill.

7. The security window of claim 1 in which each said extruded window frame element has mitered corners.

8. The security window of claim 1 further comprising a corner cover between each adjacent pair of said extruded window frame elements that secures each adjacent pair of said extruded window frame elements together.

9. An extruded window frame element that comprises:
a front frame portion;
a side frame portion;
a retainer bar;
a hinge that connects said front frame portion to said retainer bar; and
said retainer bar oriented to receive a mesh infill such that when the extruded window frame element is installed to create a window, the mesh infill is pressed between said front frame portion and said retainer bar and is also wrapped around said retainer bar.

10. The extruded window frame element of claim 9 further comprising a plurality of teeth located between said front frame portion and said retainer bar to further secure the mesh infill between said front frame portion and said retainer bar.

11. The extruded window frame element of claim 9 in which said side frame portion further comprises an opening to receive a compression connection.

12. The extruded window frame element of claim 9 further comprising:
said side frame portion further comprises an opening to receive a compression connection; and
a compression cover comprising:
a compression connection that fits into said opening; and
a mesh cover that extends from said compression connection to said hinge to cover the mesh infill between said mesh cover and said retainer bar when the extruded window frame element is installed to create a window.

13. The extruded window frame element of claim 9 further comprising:
said side frame portion further comprises an opening to receive a compression connection; and
a compression cover comprising:
a compression connection that fits into said opening;
a mesh cover that extends from said compression connection to said hinge to cover the mesh infill between said mesh cover and said retainer bar when the extruded window frame element is installed to create a window; and
an accessory located adjacent to said side frame portion.

14. The extruded window frame element of claim 9 further comprising a gasket interposed between said side frame portion and the mesh infill.

15. The extruded window frame element of claim 9 in which the extruded window frame element has mitered corners.

16. A method for assembling a security window comprising:
hemming a mesh infill to fit the desired size, shape, and number of sides to fit a finished security window;
selecting a number of extruded window frame elements that equals the number of sides of the mesh infill in which each extruded window frame element has a front frame portion, a side frame portion, a retainer bar, and a hinge that connects the front frame portion to the retainer bar;
for each side of the mesh infill:
inserting the side of the mesh infill into an extruded window frame element between the retainer bar and the front frame portion;
aligning the mesh infill so that it further wraps around the retainer bar; and
compressing the retainer bar so that the mesh infill is pressed and secured between the retainer bar and the front frame portion to create a window frame mesh assembly.

17. The method of claim 16 where the mesh infill comprises three or more sides further comprising securing each pair of adjacent window frame mesh assemblies to a corner cover to create a complete security window.

18. The method of claim 16 further comprising inserting a gasket between the mesh infill and the side frame portion of each window frame mesh assembly.

19. The method of claim 16 wherein the side frame portion of each extruded window frame element has an opening to receive a compression connection and further comprising
installing a compression cover that comprises a compression connection that fits into the opening and a mesh cover that extends from the compression connection to the hinge to cover the mesh infill between the mesh cover and the retainer bar.
